(19) United States
(12) Patent Application Publication
(10) Pub. No.: US 2006/0086455 A1
(43) Pub. Date: Apr. 27, 2006

(54) Method of labeling rubber component bags

(76) Inventors: Larry Laurenzi, Avon, OH (US); Giles Manias, Broadview Hts., OH (US); David Safenovitz, Beach wood, OH (US); Joseph Drasner, Boynton Beach, FL (US); Jason Drasner, Solon, OH (US)

Correspondence Address: Timothy D. Bennett;Brouse McDowell, LPA, Ste. 500, 106 S. Main Street, Akron, OH, 44308-1471, US

(21) Appl. No.: 10/974,156

(22) Filed: Oct. 27, 2004

(51) Int. Cl. B32B 37/00; B65C 9/18; B32B 38/10

(52) U.S. Cl. 156/247; 156/250

(57) ABSTRACT

A method of labeling rubber component bags is provided. The method includes the steps of: (1) forming a label having a first side with an adhesive and a second side; (2) applying a first identifying marker to the second side of the label; (3) adhering the label to a bag adapted to hold a component to be used in making rubber; (4) inserting the bag and the label into a rubber mixing machine used to form the rubber mixture; and, (5) mixing the label into rubber mixture. Labels formed according to the method of this invention melt and disperse throughout the rubber mixture without negatively affecting the properties of the rubber mixture.

### I. BACKGROUND OF THE INVENTION

A. Field of Invention

This invention relates to apparatuses and methods for the manufacture of rubber and more particularly to apparatuses and methods for labeling rubber component bags that are supplied to a rubber mixing machine.

B. Description of the Related Art

It is well known in the rubber industry to mix various components to form a rubber mixture or batch that can then be formed into a rubber product such as a tire, a hose, a shoe sole, etc. These various components are added to a mixing machine, such as a Banbury mixer, where they are blended into a homogenous rubber mixture. Particular rubber mixtures, known as compounds, vary greatly. This means that the components added to the mixture or batch also vary greatly. As a result, it is very important to be able to carefully and accurately identify and keep track of (including for inventory purposes) the rubber components and their quantities that are added into the mixture.

A well known problem in the art is the lack of methods to accurately identify the various components in a manner that can be controlled with inventory systems and easily read by the operators who add the components to the rubber mixing machine. FIG. 1 shows a prior art rubber component bag 1 filled with a component 2. The particular component 2 can be any component that can be used in the manufacture of rubber. The problem with the rubber component bag 1 of FIG. 1 is what is not shown; namely, an identification label. As noted above, such identification is required both for the tracking of inventory and also so that the operators are certain as to what components (and what quantities of components) are being added to the mixing machine.

One potential method of labeling would be to attach any known label, such as a label formed of a paper product, to the component bag. However, the use of such paper based labels, or any type of label known in the industry, leads to a rubber mixture that is unacceptable for use in the formation of rubber products if the label is added to the mixture. As a result, the use of all known labels destroys the batch and thereby can create waste that can be very expensive.

One method of trying to solve this problem is by using labels that can be removed prior to the component bag being added to the mixing machine. This solution, however, has the disadvantage of requiring extra steps by the operator in removing such labels and also requires the accumulation of these labels as waste. This solution also has the disadvantage that if an operator would forget to remove even a single known label, and allow it to enter the mixing machine, the batch would be destroyed and unusable.

Another solution to this problem is using a handwritten label such shown with reference 3 in FIG. 2. This solution has the advantage of not destroying the batch provided that the ink used in creating the handwritten label will not damage the mixture. However, this solution has the disadvantage of requiring time for the operator to write down the required information. It also has the disadvantage of permitting unintentional errors by the operator which could lead to confusion as to what components should be added to the mixture. Another problem with this solution, as shown in FIG. 3, is that the handwritten label 3 can easily be defaced or “smudged.” When the handwritten label is smudged it then becomes impossible to verify just what component and/or quantity of component is within the rubber component bag 1. Thus again, errors in properly identifying the components become more likely than desired. Still another problem with this solution is that it is virtually impossible to manually add bar code information and thus handwritten labels are not easily tracked.

What is needed then is a method of labeling rubber component bags in a manner that will not destroy the rubber batch. It also is desirous to have such labeling to be easy to use and work well with any kind of inventory control systems such as computer systems that are well known.

### II. SUMMARY OF THE INVENTION

According to one aspect of this invention, a method of labeling rubber component bags is provided. This method includes the steps of: (1) forming a label having a first side with an adhesive and a second side; (2) applying a first identifying marker to the second side of the label; (3) adhering the label to the bag adapted to hold a component to be used in making rubber; (4) inserting the bag and the label into a rubber mixing machine used to form a rubber mixture; and, (5) mixing the label into the rubber mixture.

According to another aspect of this invention, the label is formed from a thermoplastic material having a melt temperature of 170° F. or lower. Most preferably the label is formed from a film of an ethylene vinyl acetate copolymer having a vinyl acetate content of about 25% by weight.

According to another aspect of this invention, the label material is formed by the following process: (1) the material is formed into a relatively wide roll; (2) an adhesive coating is added to one side of the roll; (3) a liner is added to cover the adhesive coating; (4) the thermoplastic roll is sectioned into smaller rolls of about 2 inches in width; (5) slits are cut into the liner for easy subsequent removal of the liner; (6) indication marks are provided on the liner; and, (7) perforations are formed into the roll to define edges for individual labels.

According to still another aspect of this invention, the identifying marker placed on the label is barcode readable. Most preferably the barcode is placed onto the label with a conventional label printing machine.

One advantage of this invention is that labels can be easily added to rubber component bags and can be supplied directly into the mixing machine.

Another advantage of this invention is that the labels can include barcodes for easy readability by barcode reading machinery. This permits the rubber components to be easily inventory controlled.

Still another advantage of this invention is that the label melts and disperses throughout the rubber mixture without negatively affecting the properties of the rubber mixture.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a top view of a prior art rubber component bag shown without a label.

FIG. 2 is a view similar to that shown in FIG. 1, but showing a handwritten label added to the rubber component bag.

FIG. 3 is a view similar to FIG. 2, but showing how the handwritten label can easily be defaced or smudged and thus becomes non-readable.

FIG. 4 shows a rubber component bag have a label according to this invention attached to the bag.

FIG. 5 is a perspective view showing a portion of a label roll section.

FIG. 6 is a close-up view of one end of the label roll shown in FIG. 5.

FIG. 7 shows a label printing machine which can be used to add identifying markings, including barcodes, to the labels according to this invention.

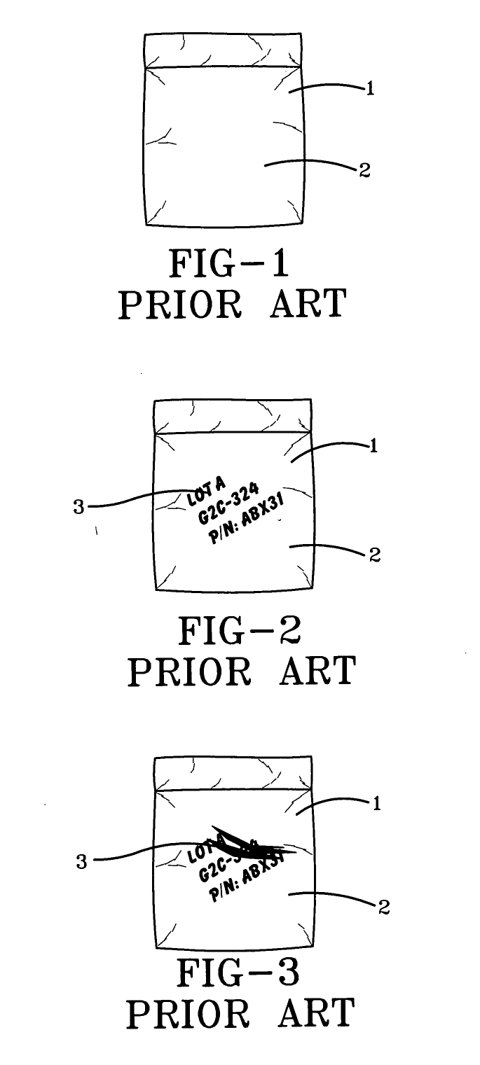

### IV. DESCRIPTION OF THE PREFERRED EMBODIMENT

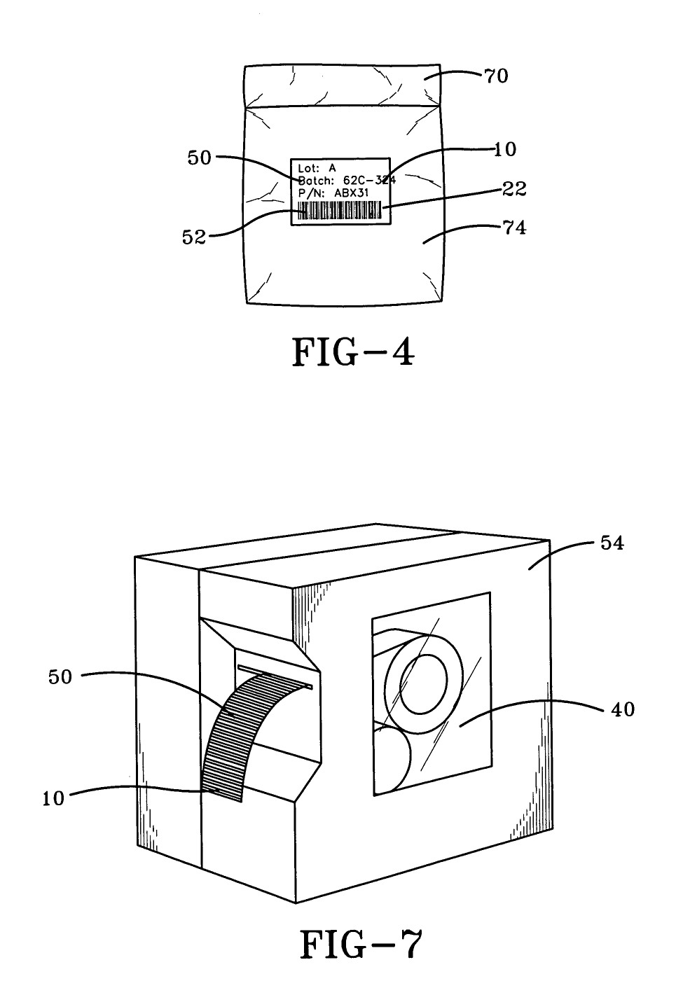

Referring now to the drawings wherein the showings are for purposes of illustrating a preferred embodiment of the invention only and not for purposes of limiting the same, FIG. 4 shows a bag 70 intended for use in holding a rubber component 74 equipped with a label 10 of this invention. The label 10 includes at least a first identifying marking 50 which can be used for any purpose in identifying the component 74 within the bag 70. The identifying marking 50 shown includes alphanumeric information as well as a barcode 52. It should be understood that any type of identifying marking 50 which would assist in identifying the component 74 can be used with this invention. Shown for illustrative purposes only is a lot number, a batch number, and a pin number.

With reference now to FIGS. 4-7, a method for making labels 10 according to this invention will now be described. The method of labeling of rubber component bags 70 according to this invention comprises the following steps: (1) forming a label 10 having a first side 14 with an adhesive 18 and a second side 22; (2) applying at least a first identifying marking 50 to the second side 22 of the label 10; (3) adhering the label 10 to a bag 70 adapted to hold the component 74 to be used in making rubber; (4) inserting the bag 70 and the label 10 into a rubber mixing machine used to form a rubber mixture; and, (5) mixing the label 10 into the rubber mixture.

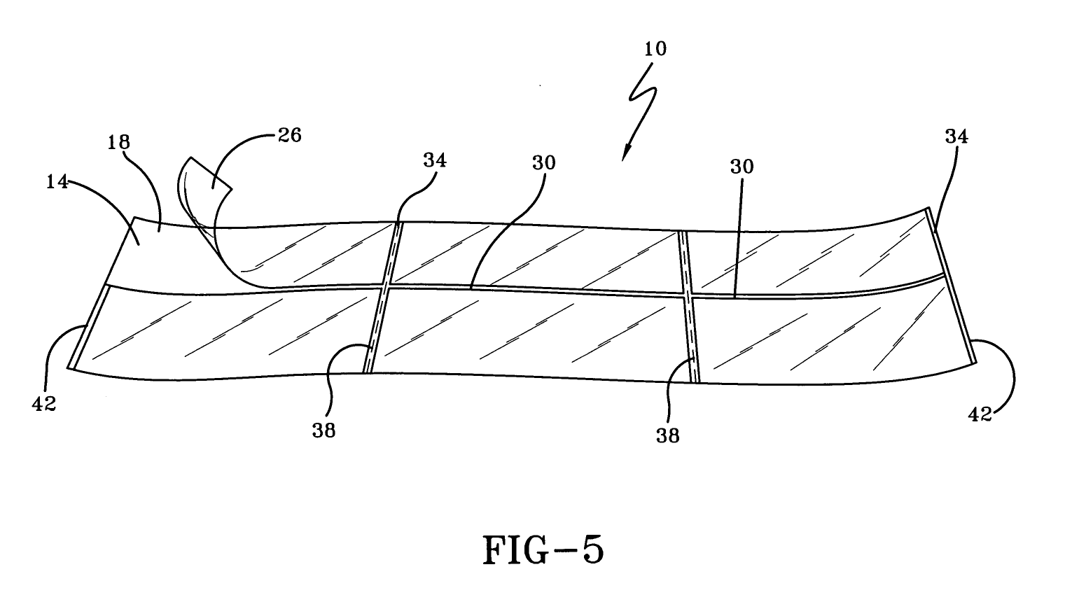

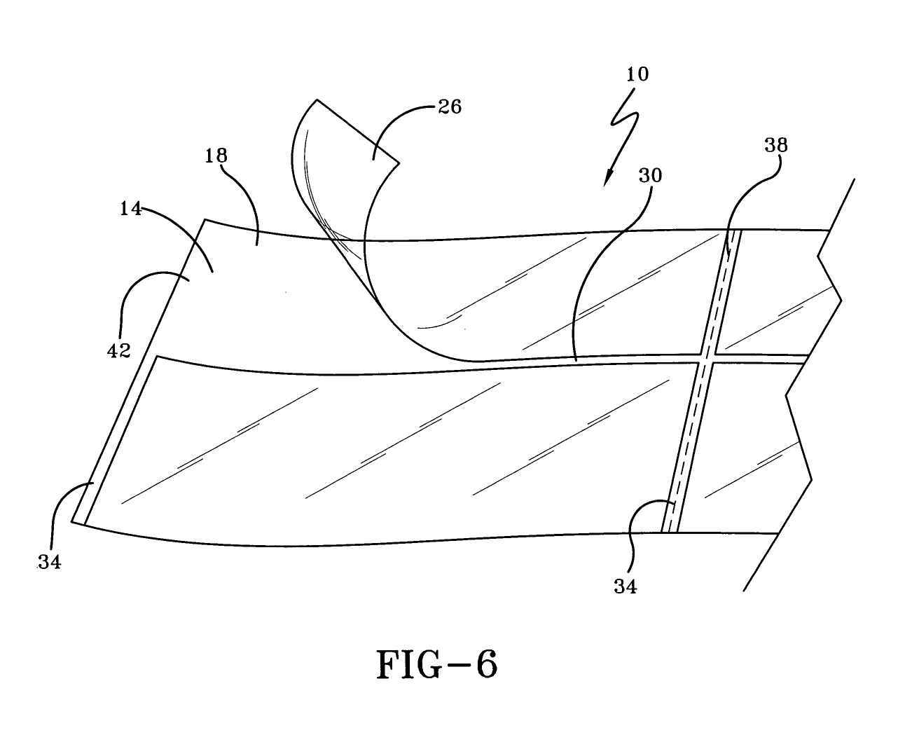

With reference now to FIGS. 5-6, it should be noted that in the preferred embodiment the label 10 is formed from a thermoplastic material having a melt temperature of 170° or lower. This temperature requirement is preferred because it greatly improves the chances that the material may be melted and dispersed during the mixing of the various rubber components 74 in a manner that will not negatively affect the properties of the end rubber mixture. More preferably, the labels 10 according to the invention are formed from a film of an ethylene vinyl acetate copolymer having a vinyl acetate content of at least about 25% by weight. Most preferably, the label 10 according to this invention is made out of the material provided in U.S. Pat. No. 5,120,787 to Drasner, a common inventor to this patent, which patent is hereby incorporated by reference. It is also preferred that the label 10 be formed of a material that is substantially white in color as shown in the FIGURES. This creates an appropriate contrast, as shown in FIG. 4, for the addition of identifying markers for easy readability both by a human as well as by any type of barcode 52 reading device.

With reference now to FIGS. 5-7, a method of converting the label material into individual labels 10 according to this invention will now be described. The label material is first formed into a large roll which may, for example, have a width of 23 inches. Next, an adhesive coating is added to one side of the roll and a liner 26 is then used to cover or coat the adhesive coating. In other words, this liner 26 protects the adhesive coating on the label material. While the liner 26 can be formed of any material chosen with sound engineering judgment, in the preferred embodiment the liner 26 is formed of a synthetic material. Next the large roll is sectioned into smaller width rolls (reference 40 in FIG. 7) such as, for example, 2 inch roll widths. Preferably slits 30 are then added to the liner 26 to make the liner 26 easy to remove when labels 10 are being attached to rubber component bags 70. It is also preferred that indication marks 34 are provided on the sectioned rolls 40 so that perforations 38 can be added as well. The perforations 38 preferably are added to the label material as well as to the liner 26. In this way the perforations 38 define an edge for each individual label 10.

With reference now to FIGS. 4 and 7, once the label sections 40 have been formed, particular identifying markings 50 may be added to the second side 22, which is the non-adhesive side, of the labels 10. To do this, the sectioned roll 40 may be added to a conventional label printing machine 54. The label printing machine 54 can then be used to add the desired identifying marking 50 to the label 10. In a preferred embodiment the first identifying marking 50 includes at least a portion that is barcode readable. This barcode 52 can easily be added with the use of the label printing machine 54. However, it should be understood that other means of adding the identifying marking 50, whether barcode readable or not, can be used with this invention.

With reference again to FIGS. 4-7, in order to attach the label 10 to the component bag 70, an individual label 10 is first removed from the sectioned roll 40 by breaking it away at a perforation 38. Next, the liner 26 can be peeled away from the adhesive side of the label 10. The label 10 can then be adhered by attaching the adhesive side (the first side 14 having the adhesive 18) to the outer surface of the rubber component bag 70. Importantly, now the entire rubber component bag 70, including the inventive label 10, can be added to the rubber mixture. Inside the rubber mixing machine the label 10 will melt and disperse throughout the rubber mixture without negatively affecting the properties of the rubber mixture in any way.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A method of labeling rubber component bags comprising the steps of:
forming a label having a first side with an adhesive and a second side;
applying at least a first identifying marking to the second side of the label;
adhering the label to a bag adapted to hold a component to be used in making rubber;
inserting the bag and the label into a rubber mixing machine used to form a rubber mixture; and,
mixing the label into the rubber mixture.

2. The method of claim 1 wherein the step of forming a label having a first side with an adhesive and a second side comprises the step of:
forming the label from a thermoplastic having a melt temperature of 170° F. or lower.

3. The method of claim 2 wherein the step of forming the label from a thermoplastic having a melt temperature of 170° F. or lower comprises the step of:
forming the label from a film of an ethylene vinyl acetate copolymer having a vinyl acetate content of at least about 25% by weight.

4. The method of claim 2 wherein the step of forming the label from a thermoplastic having a melt temperature of 170 degrees F. or lower comprises the step of:
forming the label to be substantially white in color.

5. The method of claim 2 wherein the step of forming a label having a first side with an adhesive and a second side comprises the steps of:
rolling the thermoplastic into a roll;
adding an adhesive coating to one side of the roll; and,
adding a liner to cover the adhesive coating.

6. The method of claim 5 wherein after the step of adding a liner to cover the adhesive coating, the method comprises the steps of:
sectioning the thermoplastic roll; and
cutting slits into the liner for easy removal of the liner.

7. The method of claim 6 further comprising the steps of:
providing indication marks on the liner; and,
providing at least a first perforation into the roll to define an edge of the label.

8. The method of claim 1 wherein the step of applying at least a first identifying marking to the second side of the label comprises the step of:
forming the first identifying marking to be bar code readable.

9. The method of claim 8 wherein the step of forming the first identifying marking to be bar code readable comprises the step of:
forming the first identifying marking with a label printing machine.

10. The method of claim 1 wherein the step of mixing the label into the rubber mixture comprises the step of:
melting and dispersing the label throughout the rubber mixture without negatively affecting the properties of the rubber mixture.
